(19) United States
(12) Patent Application Publication
(10) Pub. No.: US 2026/0193025 A1
(43) Pub. Date: Jul. 9, 2026

(54) TRASH CAN

(71) Applicant: EKO GROUP LTD, Jiangmen (CN)

(72) Inventor: Yizhi CHEN, Jiangmen (CN)

(21) Appl. No.: 19/553,548

(22) Filed: Mar. 2, 2026

(30) Foreign Application Priority Data
Sep. 8, 2025 (CN) 202511276156.7

(51) Int. Cl. B65F 1/14; B65B 51/14; B65F 1/06

(52) U.S. Cl. CPC B65F 1/14; B65B 51/146; B65F 1/06

(57) ABSTRACT

A trash can includes a drive mechanism, a frame assembly, a first gathering assembly, a second gathering assembly and a heating element. The drive mechanism is configured to move along a first direction, and the frame assembly is arranged along a second direction perpendicular to the first direction. The frame assembly is connected to the drive mechanism. The first and second gathering assemblies are arranged in the frame assembly. The first gathering assembly is drivably connected to the drive mechanism, and the second gathering assembly is drivably connected to the first gathering assembly. The first gathering assembly and the second gathering assembly are at least partially in contact with each other. The heating element is arranged in the first gathering assembly or the second gathering assembly.

### CROSS-REFERENCE TO RELATED APPLICATIONS

This application claims the benefit of priority from Chinese Patent Application No. 202511276156.7, filed on September 8, 2025. The content of the aforementioned application, including any intervening amendments thereto, is incorporated herein by reference in its entirety.

### TECHNICAL FIELD

This application relates to trash cans, and more particularly to a trash can.

### BACKGROUND

For the existing trash cans, it is generally required to gather the bag opening to a preset fixing area at the top of the trash can via a mechanical mechanism, and then thermally seal the bag opening through a heat-sealing mechanism installed at the fixing area to complete the packaging and sealing of the garbage bag. However, the gathered bag opening is prone to wrinkling, thereby making the gathered portion too thick and uneven. As a consequence, the heat-sealing device cannot evenly and completely heat and seal the opening of the garbage bag, resulting in odor leakage or seal breakage.

### SUMMARY

In view of this, there is an urgent need to provide a trash can to address the above technical problems.

A trash can, comprising:

a drive mechanism;

a frame assembly;

a first gathering assembly;

a second gathering assembly; and

a heating element;

wherein the drive mechanism is configured to move along a first direction; the frame assembly is arranged along a second direction; and the first direction is perpendicular to the second direction;

the frame assembly is connected to the drive mechanism, and the drive mechanism is configured to drive the frame assembly to reciprocate along the first direction;

the first gathering assembly and the second gathering assembly are provided on the frame assembly; and the frame assembly is configured to be driven by the drive mechanism to cause the first gathering assembly and the second gathering assembly to move along the first direction;

the first gathering assembly is drivably connected to the drive mechanism, and the second gathering assembly is drivably connected to the first gathering assembly, so as to enable synchronous rotation of the first gathering assembly and the second gathering assembly; and the first gathering assembly is configured to be at least partially in contact with the second gathering assembly, such that a garbage bag is gathered to a contact area between the first gathering assembly and the second gathering assembly; and

the heating element is arranged in the first gathering assembly or the second gathering assembly; and the heating element is configured to thermally cut and seal the garbage bag.

In an embodiment, the drive mechanism comprises a drive assembly and a transmission assembly; the drive assembly and the transmission assembly are arranged along the first direction; the frame assembly is connected to the drive assembly; the drive assembly is configured to drive the frame assembly to reciprocate along the first direction; the transmission assembly is partially arranged in the frame assembly; and the transmission assembly is drivably connected to the drive assembly, and the first gathering assembly.

In an embodiment, the drive assembly comprises a motor, a lead screw and a lead screw nut, wherein the motor is connected to the lead screw; the lead screw nut is threadedly connected to the lead screw; the frame assembly is connected to the lead screw nut; the motor is configured to drive the lead screw to rotate to cause the lead screw nut to reciprocate along the lead screw; and the lead screw nut is configured to drive the frame assembly to move along the first direction.

In an embodiment, the transmission assembly comprises a worm gear and a worm; the worm is drivably connected to the motor, and the worm gear is sleeved on the worm; the motor is configured to drive the worm to rotate, so as to drive the worm gear to rotate; the worm gear is arranged in the frame assembly; the frame assembly is configured to drive the worm gear to reciprocate along the worm; and the worm gear is drivably connected to the first gathering assembly.

In an embodiment, the trash can, further comprising:

a synchronous pulley set arranged in the frame assembly;

wherein and the synchronous pulley set comprises a first synchronous pulley, a second synchronous pulley and a synchronous belt; the first synchronous pulley is arranged spaced apart from the second synchronous pulley in the frame assembly; the first synchronous pulley is engaged with the worm gear; the second synchronous pulley is drivably connected to the first gathering assembly; the worm gear is configured to drive the first synchronous pulley to rotate; and the synchronous belt is sleeved on the first synchronous pulley and the second synchronous pulley to allow the first synchronous pulley and the second synchronous pulley to rotate synchronously.

In an embodiment, the first gathering assembly comprises a first drive wheel set and a first drive belt; the first drive wheel set is drivably connected to the second synchronous pulley; the first drive belt is sleeved on the first drive wheel set; and the first drive belt is configured to be driven by the first drive wheel set to move along an outer peripheral surface of the first drive wheel set.

In an embodiment, the second gathering assembly comprises a second drive wheel set and a second drive belt; the second drive wheel set is drivably connected to the first drive wheel set; the second drive belt is sleeved on the second drive wheel set; the second drive belt is configured to be driven by the second drive wheel set to move along an outer peripheral surface of the second drive wheel set; and the first drive belt is configured to be at least partially in contact with the second drive belt.

In an embodiment, the trash can, further comprising:

a first pushing ramp;

wherein the first pushing ramp is arranged in the second gathering assembly; the first pushing ramp is arranged spaced apart from the heating element; the first pushing ramp comprises a first inclined surface, wherein the first inclined surface is arranged facing towards the heating element; and the first pushing ramp is configured to move with the frame assembly along the first direction.

In an embodiment, the trash can, further comprising:

a second pushing ramp;

wherein the second pushing ramp is arranged spaced apart from the first pushing ramp; the second pushing ramp comprises a second inclined surface, wherein the second inclined surface is parallel to the first inclined surface; and the second inclined surface is configured to cooperate with the first inclined surface to separate an opening of the garbage bag from a main body of the garbage bag.

In an embodiment, the trash can, further comprising:

an abutting mechanism arranged in the frame assembly;

wherein the abutting mechanism is configured to protrude beyond the first gathering assembly, and press against an opening of the garbage bag to eliminate a gap between two sides of the garbage bag.

Compared to the prior art, the present disclosure has the following beneficial effects.

The trash can in the present disclosure achieves gathering and sealing of the garbage bag through the cooperation of the drive mechanism, the frame assembly, and the gathering assemblies. Specifically, the first and second gathering assemblies are arranged in the frame assembly, and the drive mechanism can drive the first and second gathering assemblies to move along the first direction. Furthermore, the drive mechanism is drivably connected to the first gathering assembly, and the second gathering assembly is drivably connected to the first gathering assembly, such that belts of the first and second gathering assemblies can move along their peripheral surfaces, respectively. Consequently, as the frame assembly moves along the first direction, the first and second gathering assemblies are driven by the frame assembly to move toward the garbage bag to ensure the garbage bag to be gathered into the contact area between the first and second gathering assemblies. After reached the contact area, the opening of the garbage bag is thermally cut and sealed by the heating element.

For the trash can provided herein, the first and second gathering assemblies approach the garbage bag from two sides to gather the garbage bag into the contact area between the first and second gathering assemblies, and the thermal-melting is simultaneously performed during the gathering process, thereby preventing the occurrence of excessive wrinkles and ensuring a uniform thickness at the opening of the garbage bag. As a consequence, the thermal sealing effect is enhanced, reducing the occurrence of odor leakage or seal breakage.

### BRIEF DESCRIPTION OF THE DRAWINGS

In order to illustrate the technical solutions in the embodiments of the present disclosure or in the prior art more clearly, the accompanying figures needed in the description of the embodiments of the present disclosure or the prior art will be briefly introduced below. Obviously, the accompanying figures described below are merely some embodiments of the present disclosure. Other drawings can also be obtained by those skilled in the art based on these accompanying drawings without paying creative effort.

FIG. 1 schematically shows a trach can according to an embodiment of the present disclosure;

FIG. 2 schematically shows an accommodating cavity of the trach can according to an embodiment of the present disclosure;

FIG. 3 schematically shows an internal structure of an accommodating slot of the trach can according to an embodiment of the present disclosure;

FIG. 4 structurally shows the accommodating slot in FIG. 3 in the absence of a frame assembly;

FIG. 5 schematically shows a drive mechanism of the trach can according to an embodiment of the present disclosure;

FIG. 6 is a top view of the accommodating slot in FIG. 4;

FIG. 7 is an enlarged view of part A in FIG. 6;

FIG. 8 schematically shows a positional relationship between an abutting mechanism and a heating element according to an embodiment of the present disclosure;

FIG. 9 schematically shows the abutting mechanism according to an embodiment of the present disclosure;

FIG. 10 schematically shows a heating element, a mounting portion and a first pushing ramp according to an embodiment of the present disclosure;

FIG. 11 schematically shows the heating element and the mounting portion according to an embodiment of the present disclosure;

FIG. 12 schematically shows a rear wheel and a second pushing ramp according to an embodiment of the present disclosure;

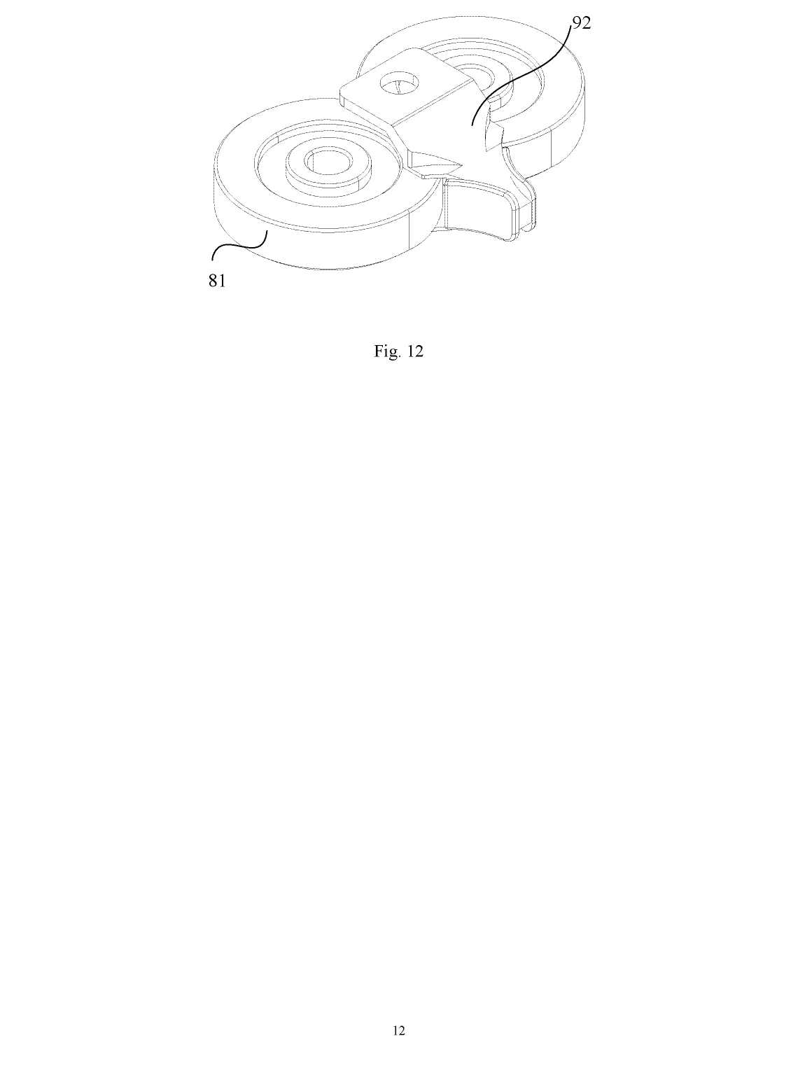

FIG. 13 schematically shows the second pushing ramp according to an embodiment of the present disclosure;

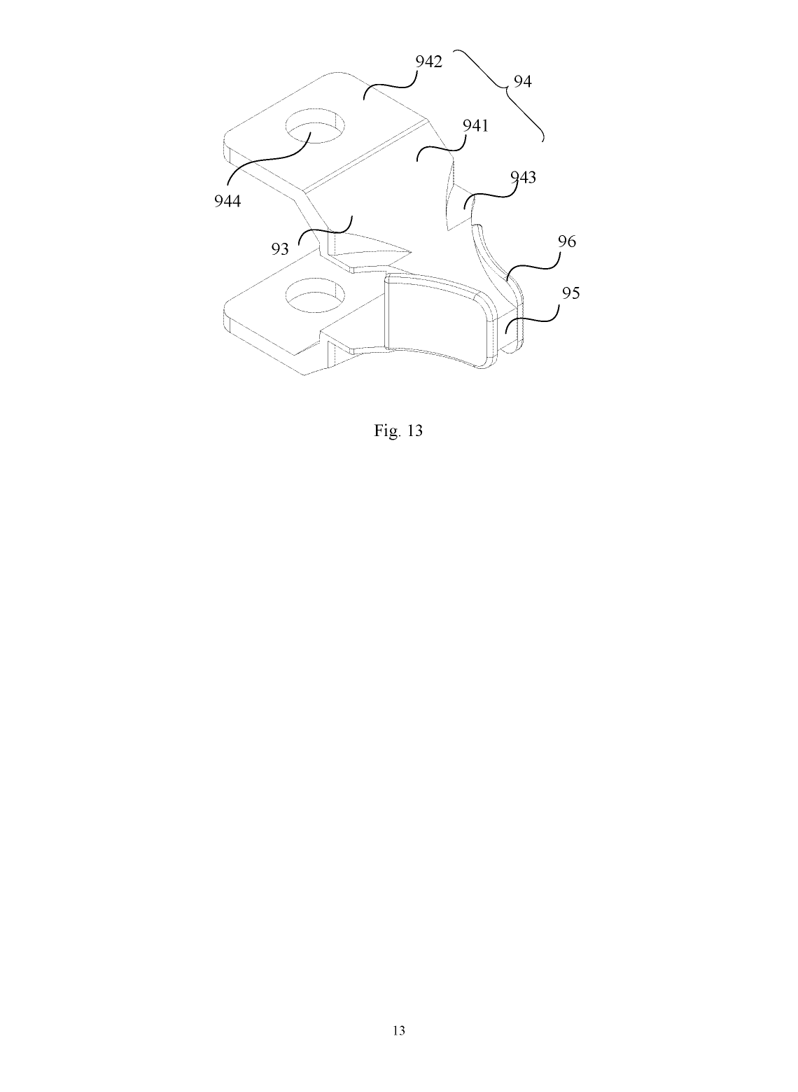

FIG. 14 schematically shows a transmission unit according to an embodiment of the present disclosure;

FIG. 15 schematically shows a lead screw according to an embodiment of the present disclosure; and

FIG. 16 schematically shows the cooperation of a worm gear and the transmission unit according to an embodiment of the present disclosure.

In the figures: 1-trash can body; 11-accommodating slot; 12-accommodating cavity; 121-opening; 13-guide rail; 14-sensor; 15-return spring; 16-controller; 17-first direction; 18-second direction; 2-drive mechanism; 21-drive assembly; 211-motor; 212-transmission unit; 2121-drive shaft; 2122-drive gear set; 2123-first drive gear; 2124-second drive gear; 2125-first connecting segment; 2126-second connecting segment; 2127-connecting hole; 213-lead screw; 2131-insertion slot; 214-lead screw nut; 215-guide wheel; 22-transmission assembly; 221-worm gear; 222-worm; 223-first bearing; 224-second bearing; 3-frame assembly; 31-first frame; 32-second frame; 33-third frame; 34-fourth frame; 4-first gathering assembly; 41-first contact area; 42-first drive wheel set; 43-first drive belt; 44-first drive wheel; 45-second drive wheel; 46-third drive wheel; 47-tensioning wheel; 5-second gathering assembly; 51-second contact area; 52-second drive wheel set; 53-second drive belt; 54-first transmission wheel; 55-second transmission wheel; 56-third transmission wheel; 6-heating element; 61-mounting portion; 62-abutting mechanism; 621-positioning portion; 622-protruding portion; 623-first edge; 624-second edge; 625-third edge; 63-first bending portion; 64-first heating portion; 65-second bending portion; 66-second heating portion; 7-synchronous pulley set; 71-first synchronous pulley; 72-second synchronous pulley; 73-synchronous belt; 74-idle gear; 8-rear wheel set; 81-rear wheel; 82-rear supporting block; 9-first pushing ramp; 91-first inclined surface; 92-second pushing ramp; 93-second inclined surface; 94-pushing arm; 941-pushing portion; 942-fixing portion; 943-clamping portion; 944-fixing hole; 95-connecting part; and 96-retaining edge.

The objects, features and advantages of the present disclosure will be further described in conjunction with the embodiments and the accompanying drawings.

### DETAILED DESCRIPTION OF EMBODIMENTS

The technical solutions in the embodiments of this present disclosure will be clearly and completely described below in conjunction with the accompanying figures in the embodiments of this present disclosure. Obviously, the embodiments described below are merely some of the embodiments of the present disclosure, instead of all embodiments. Based on the following embodiments, for those of ordinary skill in the art, other embodiments can be obtained without paying creative effort shall fall within the scope of this application defined by the appended claims.

It should be noted that all directional indications (such as "up", "down", "left", "right", "front", "back", etc.) used in the embodiments of this present disclosure are only used to explain the relative positional relationship or motion among the components under a specific posture (as shown in the attached figure). If the specific posture changes, the corresponding directional indication will be adjusted accordingly.

Furthermore, the expressions involving "first", "second", etc. in the present disclosure are only for descriptive purposes and should not be understood as indicating or implying the relative importance or the quantity of the technical features involved. Therefore, features defined by "first" or "second" can explicitly or implicitly indicate the inclusion of at least one of such features. In addition, with respect to the term "and / or", taking "A and / or B" as an example, it includes technical solution A, technical solution B, and a combination thereof. The technical solutions in individual embodiments can be combined with each other as long as the combined solution can be realized by one of ordinary skill in the art. If the combination of technical solutions is contradictory or unachievable, it should be considered infeasible, and does not fall within the scope of the present disclosure.

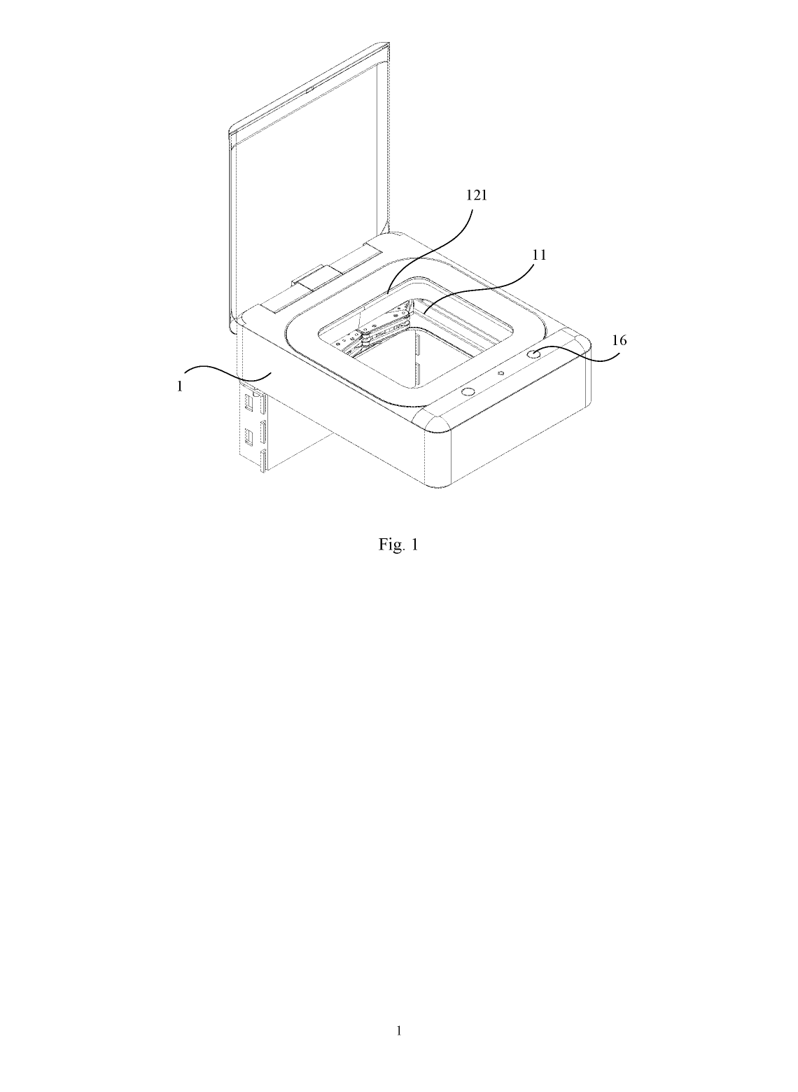

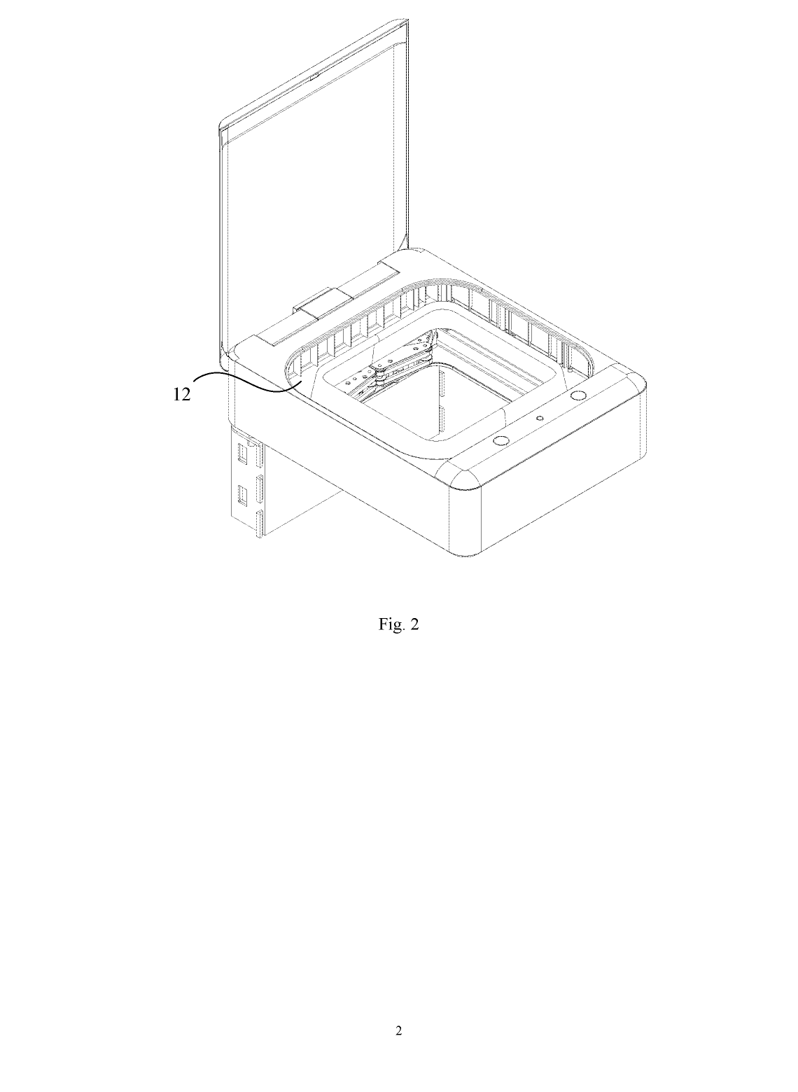

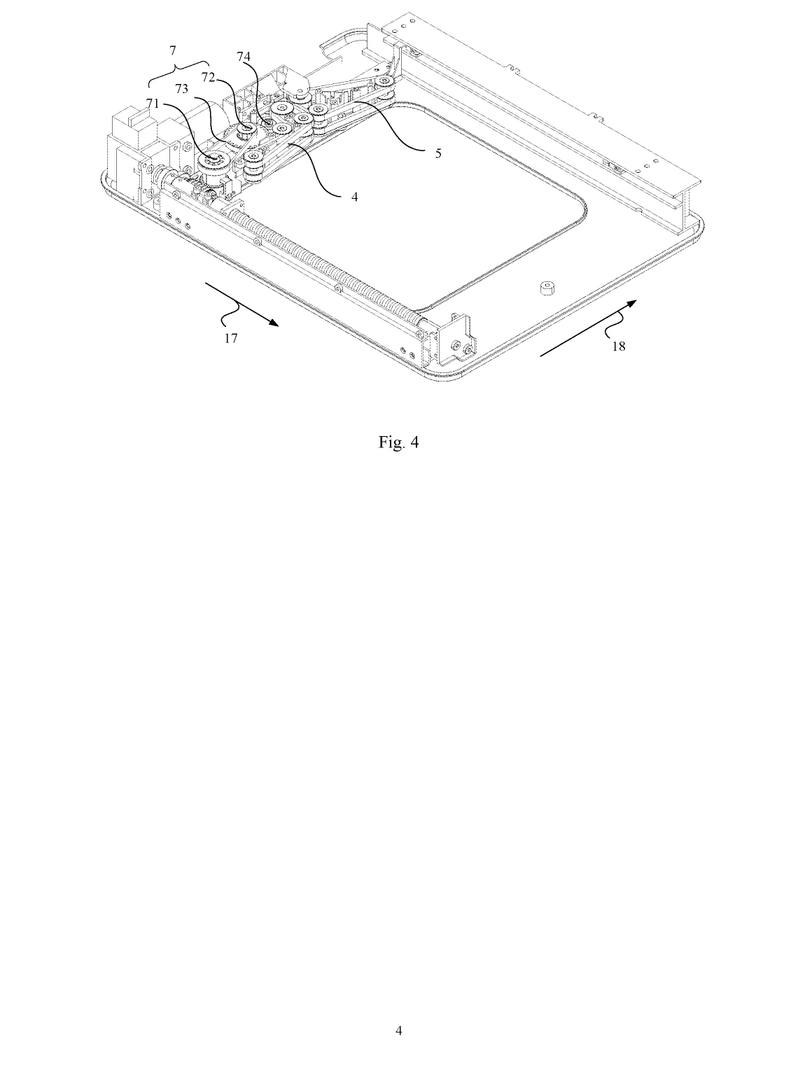

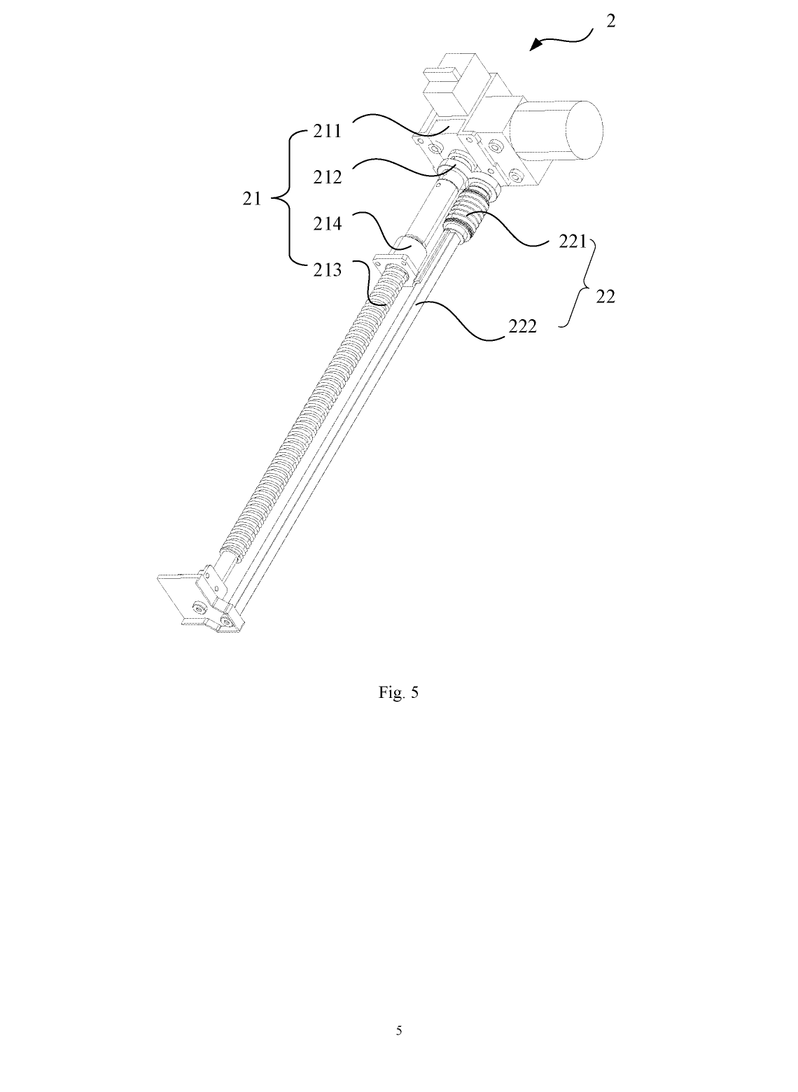

Referring to FIGS. 1-8, the present disclosure provides a trash can, including a trash can body 1, a drive mechanism 2, a frame assembly 3, a first gathering assembly 4, a second gathering assembly 5 and a heating element 6. An accommodating slot 11 and an accommodating cavity 12 are arranged spaced apart from each other along a height direction inside the trash can body 1. The accommodating slot 11 is arranged below the accommodating cavity 12, where the accommodating cavity 12 is configured to accommodate a garbage bag. An edge of an inner side of the accommodating cavity 12 is provided with an opening 121 to extend the garbage bag. The drive mechanism 2 is configured to move along a first direction 17 in the accommodating slot 11. The frame assembly 3 is arranged along a second direction 18 in the accommodating slot 11, where the second direction 18 is perpendicular to the first direction 17. The frame assembly 3 is connected to the drive mechanism 2, where the drive mechanism 2 is configured to drive the frame assembly 3 to reciprocate along the first direction 17. The first gathering assembly 4 and the second gathering assembly 5 are provided on the frame assembly 3. The frame assembly 3 is configured to be driven by the drive mechanism 2 to cause the first gathering assembly 4 and the second gathering assembly 5 to move along the direction 17. The first gathering assembly 4 is drivably connected to the drive mechanism 2, and the second gathering assembly 5 is drivably connected to the first gathering assembly 4, so as to enable synchronous rotation of the first gathering assembly 4 and the second gathering assembly 5. The first gathering assembly 4 is configured to be at least partially in contact with the second gathering assembly 5, such that the garbage bag is gathered to a contact area between the first gathering assembly 4 and the second gathering assembly 5. A heating element 6 is arranged in the first gathering assembly 4 or the second gathering assembly 5, and the heating element 6 is configured to thermally cut and seal the garbage bag.

The trash can provided herein achieves gathering and sealing of the garbage bag through the cooperation of the drive mechanism 2, the frame assembly 3, the first gathering assembly 4 and the second gathering assembly 5. Specifically, the first gathering assembly 4 and the second gathering assembly 5 are arranged in the frame assembly 3, and the drive mechanism 2 can drive the first gathering assembly 4 and the second gathering assembly 5 to move along the first direction 17. Furthermore, the drive mechanism 2 is drivably connected to the first gathering assembly 4, and the second gathering assembly 5 is drivably connected to the first gathering assembly 4, such that belts of the first gathering assembly 4 and the second gathering assembly 5 can move along their peripheral surfaces, respectively. Consequently, as the frame assembly 3 moves along the first direction 17, the first gathering assembly 4 and the second gathering assembly 5 are driven by the frame assembly 3 to move toward the garbage bag to ensure the garbage bag to be gathered into the contact area between the first gathering assembly 4 and the second gathering assembly 5. After reached a contact area, an opening of the garbage bag is thermally cut and sealed by the heating element 6.

For the trash can provided herein, the first gathering assembly 4 and the second gathering assembly 5 approach the garbage bag from two sides to gather the garbage bag into the contact area between the first gathering assembly 4 and the second gathering assembly 5, and the thermal-melting is simultaneously performed during the gathering process, thereby preventing the occurrence of excessive wrinkles and ensuring a uniform thickness at the opening of the garbage bag. As a consequence, the thermal sealing effect is enhanced, reducing the occurrence of odor leakage or seal breakage.

In an embodiment, the first gathering assembly 4 is connected to the second gathering assembly 5 via a rear supporting block 82 in the middle of the rear.

In an embodiment, the first direction 17 is a width or length direction of the trash can body 1, and correspondingly, the second direction 18 is a length or width direction of the trash can body 1.

In this embodiment, the first direction 17 is a width direction of the trash can body 1, and the second direction 18 is a length direction of the trash can body 1.

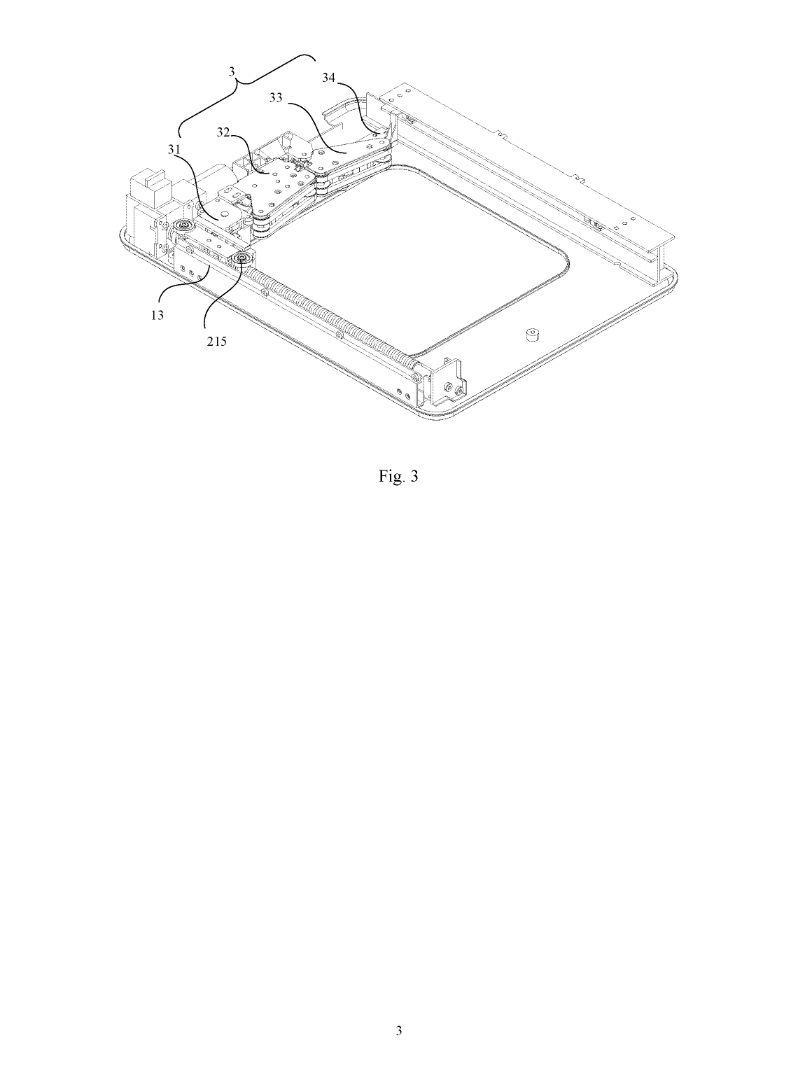

Referring to FIG. 3, the frame assembly 3 includes a first frame 31, a second frame 32 and a third frame 33, where the first frame 31, the second frame 32 and the third frame 33 are connected in sequence. The drive mechanism 2 is partially arranged in the first frame 31. The first gathering assembly 4 is arranged in the second frame 32. The second gathering assembly 5 is arranged in the third frame 33.

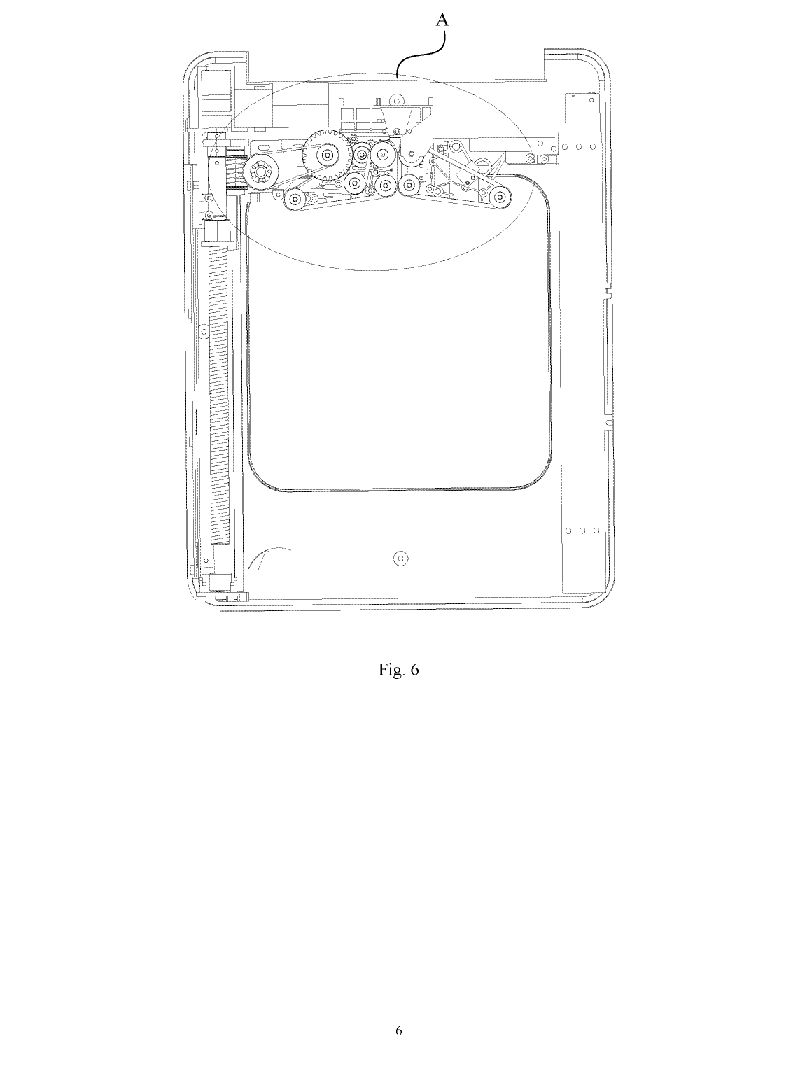

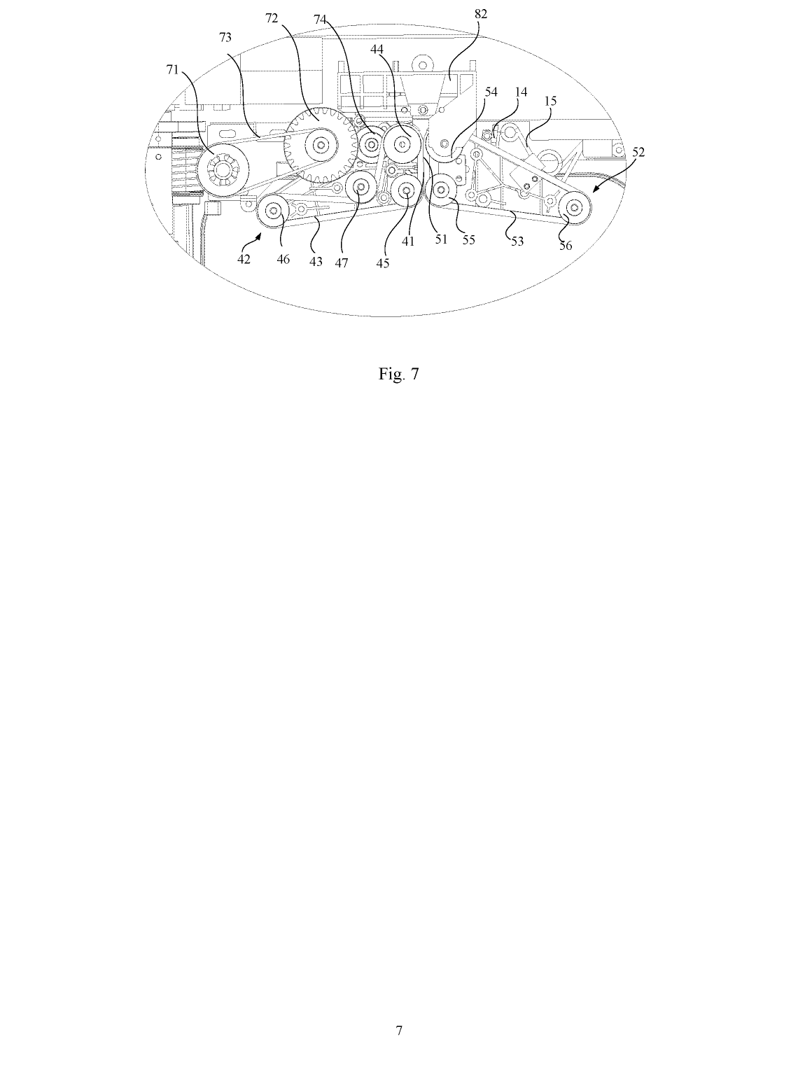

According to an embodiment in FIGS. 6-7, the first gathering assembly 4 is provided with a first contact area 41. The second gathering assembly 5 is provided with a second contact area 51. The first contact area 41 is in contact with the second contact area 51 to gather the garbage bag between the first contact area 41 and the second contact area 51.

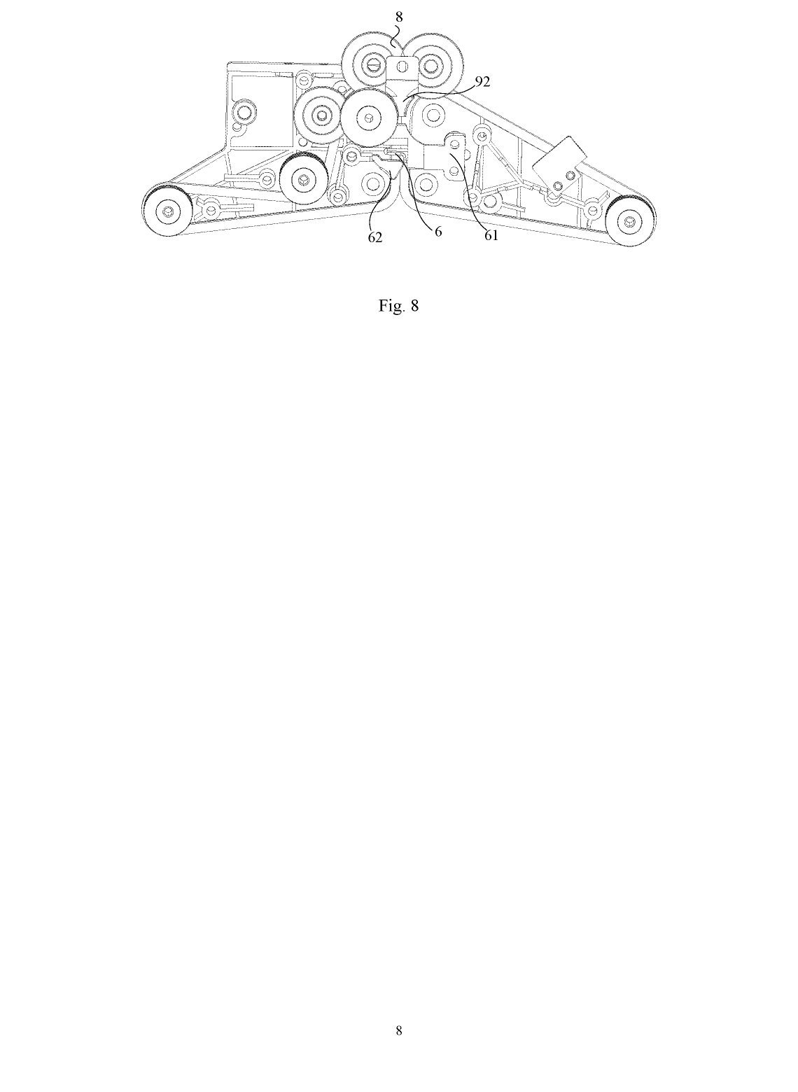

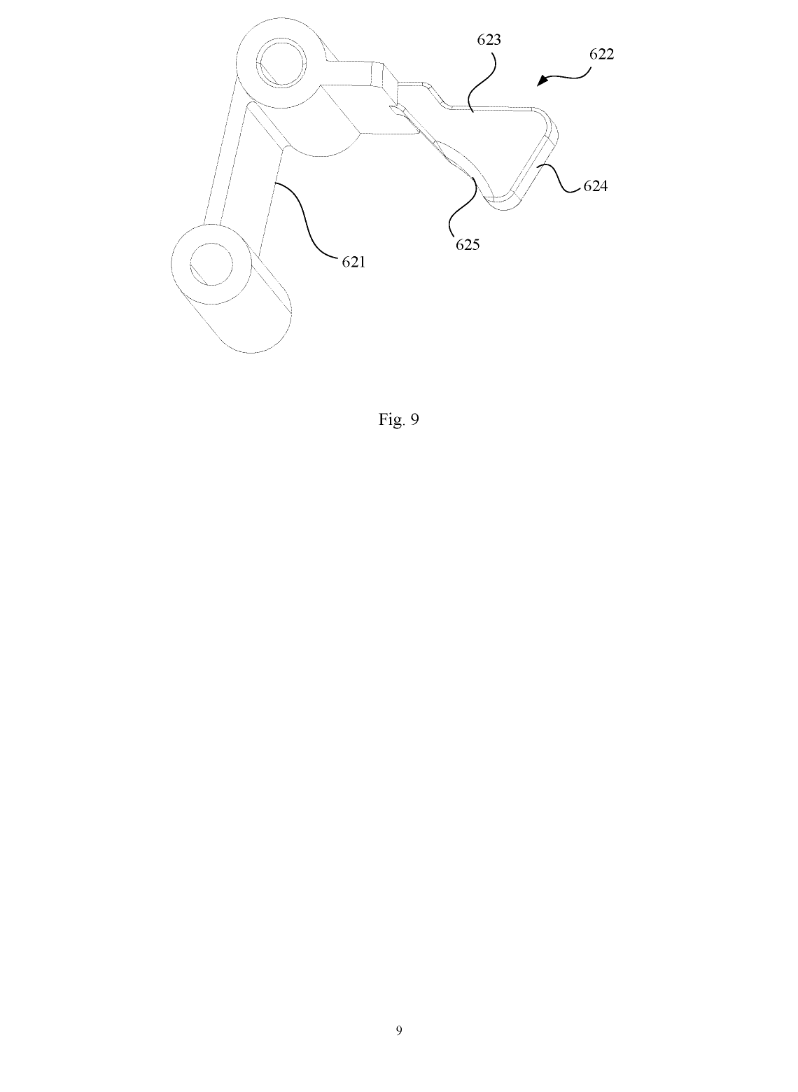

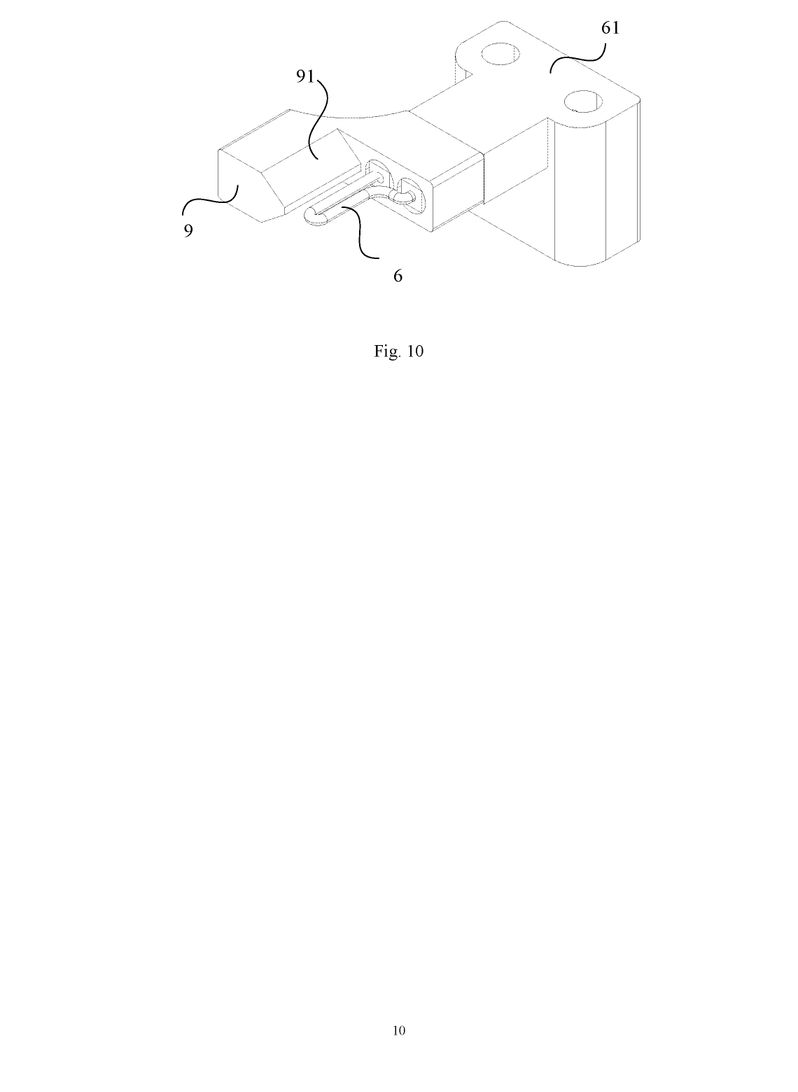

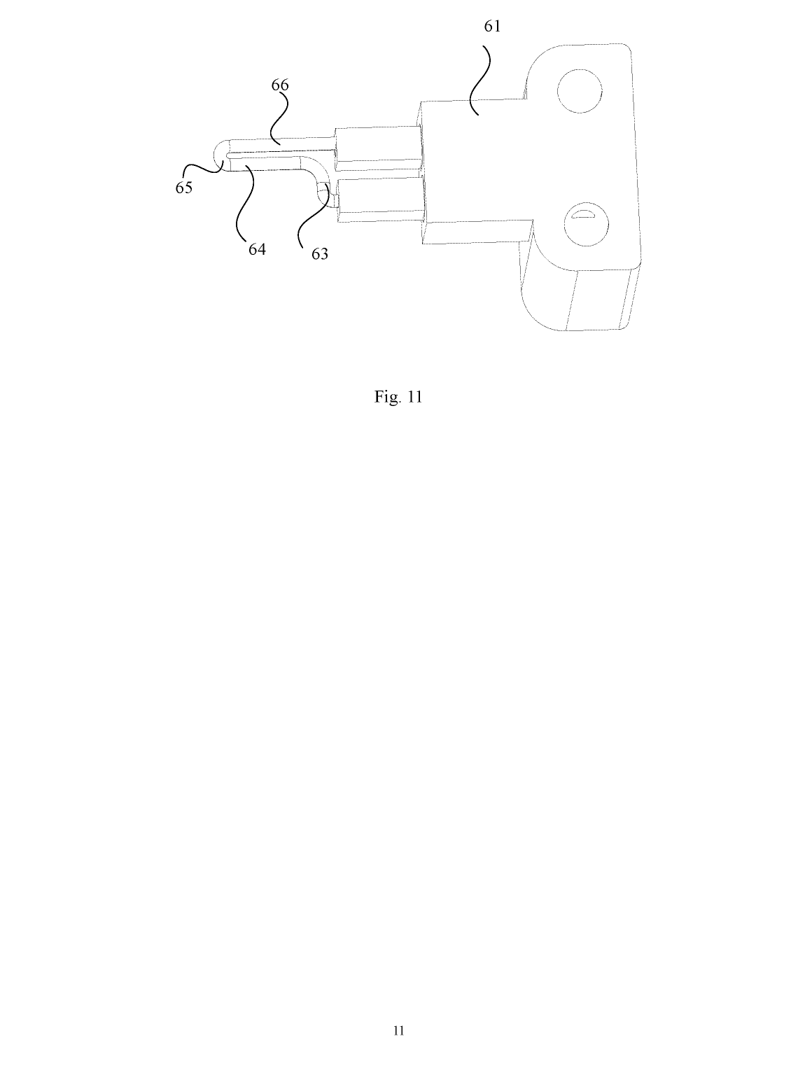

Referring to FIGS. 8-11, the trash can provided herein includes a mounting portion 61. The mounting portion 61 is arranged at an inner bottom of the third frame 33. The heating element 6 is arranged at a side of the mounting portion 61 facing toward the first gathering assembly 4. The heating element 6 is configured to be fixedly arranged in the third frame 33 via the mounting portion 61, and to extend to an exterior of the second gathering assembly 5.

The trash can provided herein includes an abutting mechanism 62. The abutting mechanism 62 is arranged in the second frame 32. The abutting mechanism 62 is arranged spaced apart from the first contact area 41 in a height direction of the trash can body 1, and the abutting mechanism 62 is configured to protrude from the first contact area 41 in a direction approaching the second contact area 51. When gathering the garbage bag, a gap is formed between two sides of the garbage bag. The gap between two sides of the garbage bag can be shortened by arranging the abutting mechanism 62 to press against the garbage bag, such that two sides of the garbage bag are enabled to fit tightly to each other during the gathering process. Thus, it allows the opening of the garbage bag to be evenly welded without the occurrence of odor leakage during thermal-melting and sealing processes, such that the sealing effect of the opening of the garbage bag is enhanced.

In an embodiment, the abutting mechanism 62 is configured to approach a center of the trash can body 1 with respect to the heating element 6.

In an embodiment, the abutting mechanism 62 includes a positioning portion 621 and a protruding portion 622. The positioning portion 621 is arranged at an inner bottom of the second frame 32. The protruding portion 622 is arranged at a side of the positioning portion 621. The protruding portion 622 is arranged spaced apart from the first contact area 41 in a height direction of the trash can boy 1, and the protruding portion 622 is configured to protrude from the first contact area 41 in a direction approaching the second contact area 51.

In an embodiment, the protruding portion 622 includes a first edge 623 and a second edge 624, where the first edge 623 is parallel to a width direction of the trash can body 1, and the second edge 624 is obliquely arranged with respect to the first edge 623. In this case, an end of the second edge 624 away from the first edge 623 is configured to obliquely extend toward the second gathering assembly 5 until the first edge 623 can be connected to the first edge 623. A transition between the second edge 624 and the first edge 623 is configured as a curved transition, such that a connection point between the first edge 623 and the second edge 624 fails to pierce the opening of the garbage bag.

In an embodiment, the second edge 624 is configured to slant through the first contact area 41 and the second contact area 51.

In an embodiment, the protruding portion 622 includes a third edge 625. A first end of the third edge 625 is connected to an end of the first edge 623, and a second of the third edge 625 is connected to an end of the second edge 624. The first edge 623, the second edge 624 and the third edge 625 are configured to enclose to form a roughly triangular shape.

In an embodiment, the heating element 6 includes a first bending portion 63, a first heating portion 64, a second bending portion 65 and a second heating portion 66. An end of the first bending portion 63 is inserted into the mounting portion 61. The second bending portion 65 is configured to extend along a width direction of the trash can body 1 away from the protruding portion 622, and be connected to an end of the first heating portion 64. The first heating portion 64 is configured to extend along a length direction of the trash can body 1 away from the mounting portion 61, and be connected to an end of the second bending portion 65. A first end of the second heating portion 66 is inserted into the mounting portion 61, and a second end of the second heating portion 66 is connected to a second end of the second bending portion 65.

In an embodiment, the heating element 6 is configured to protrude from the second contact area 51. The first heating portion 64, the second bending portion 65 are configured to protrude from the second contact area 51. The second heating portion 66 is configured to partially protrude from the second contact area 51.

Referring to FIGS. 1-7, the drive mechanism 2 includes a drive assembly 21 and a transmission assembly 22. The drive assembly 21 and the transmission assembly 22 are arranged along the first direction 17 in the accommodating slot 11. An end of the frame assembly 3 is connected to the drive assembly 21, where the drive assembly 21 is configured to drive the frame assembly 3 to reciprocate along the first direction 17. The transmission assembly 22 is partially arranged in the frame assembly 3. The transmission assembly 22 is drivably connected to the drive assembly 21, and also connected to the first gathering assemble 4.

In some embodiments, the drive assembly 21 includes a motor 211, a transmission unit 212, a lead screw 213 and a lead screw nut 214. A first end of the transmission unit 212 is connected to the motor 211, and a second of the transmission unit 212 is connected to the lead screw 213. The lead screw nut 214 is threadedly connected to the lead screw 213. The frame assembly 3 is connected to the lead screw nut 214. The motor 211 is configured to drive the transmission unit 212 to rotate, so as to drive the lead screw 213 to rotate and cause the lead screw nut 214 to reciprocate, such that the lead screw nut 214 is configured to drive the frame assembly 3 to move along the first direction 17.

In an embodiment, the drive assembly 21 includes a guide wheel 215, where the guide wheel 215 is connected to the frame assembly 3. A guide rail 13 is arranged along the first direction 17 in the accommodating slot 11. The guide wheel 215 is slidably connected to the guide rail 13.

In an embodiment, the transmission assembly 22 includes a worm gear 221 and a worm 222. The worm 222 is drivably connected to the transmission unit 212. The worm gear 221 is sleeved on the worm 222. The motor 211 is configured to drive the worm 222 to rotate via the transmission unit 212, so as to drive the worm gear 221 to rotate. The worm gear 221 is arranged in the frame assembly 31. The frame assembly 3 is configured to drive the worm gear 221 to reciprocate along the worm 222. The worm gear 221 is drivably connected to the first gathering assembly 4.

In an embodiment, the worm is square.

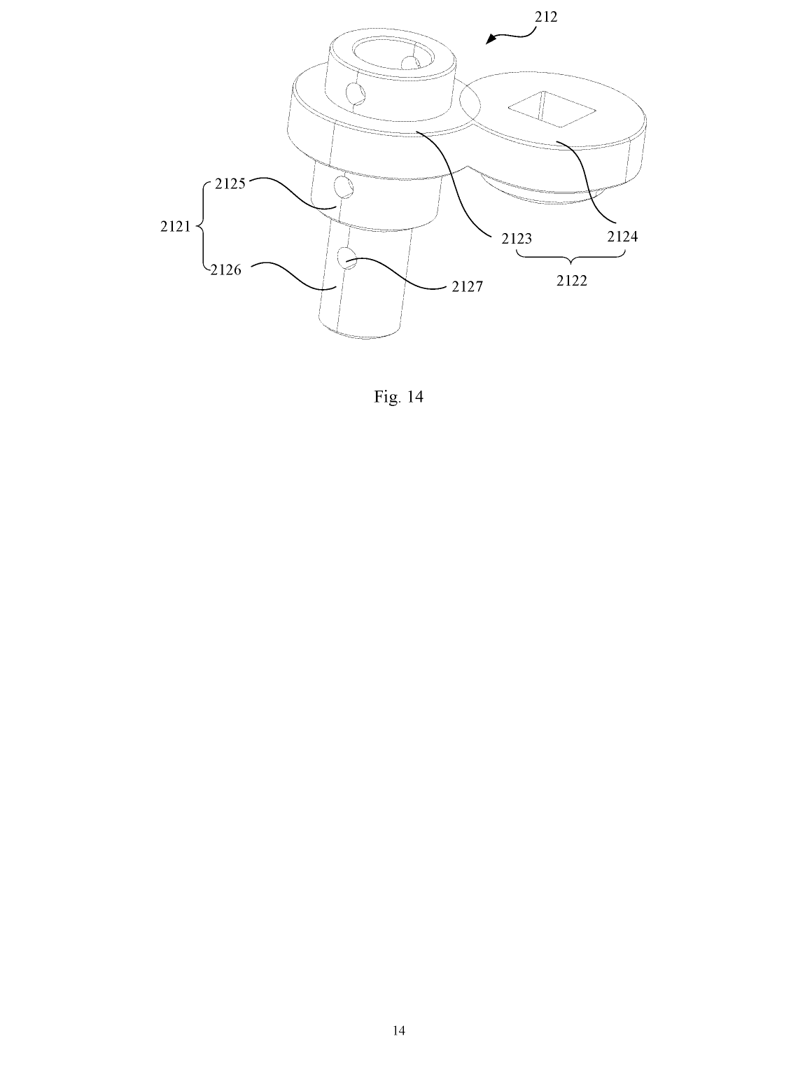

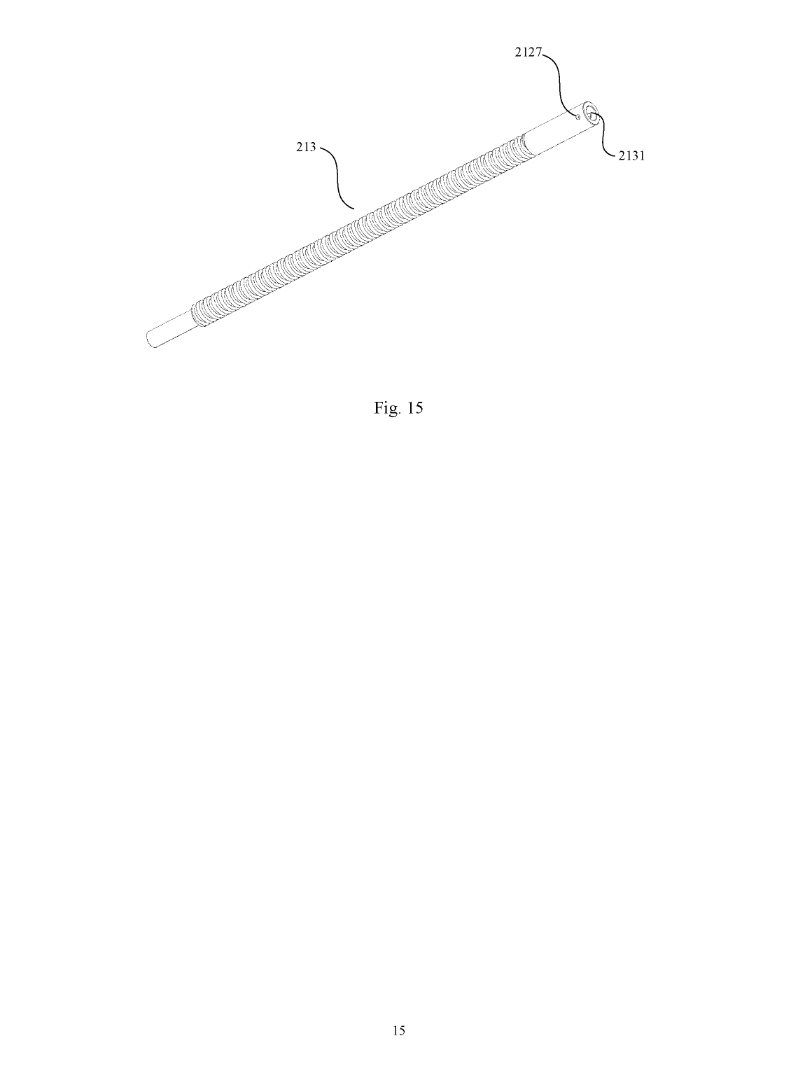

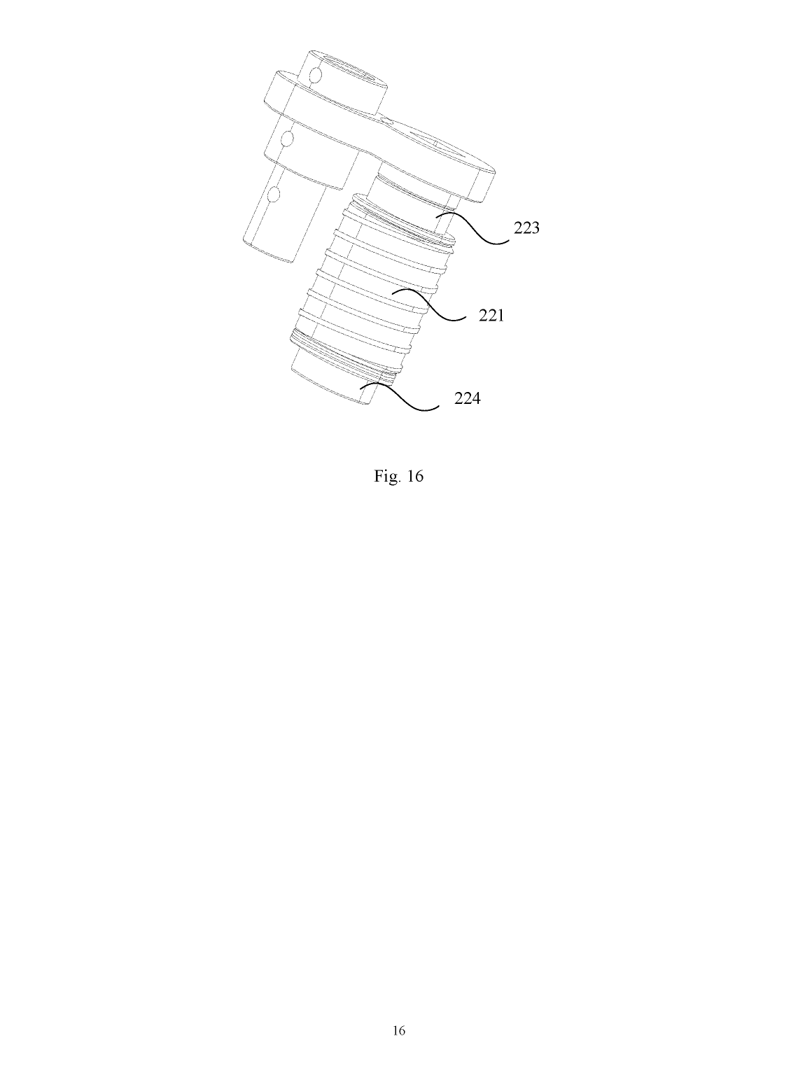

According to an embodiment in FIGS. 14-16, the transmission unit 212 includes a drive shaft 2121 and a drive gear set 2122. A first end of the drive shaft 2121 is connected to an output shaft of the motor 211, and a second of the drive shaft 2121 is connected to the lead screw 213. The drive gear set 2122 is fixedly sleeved on an exterior of the drive shaft 2121. The drive gear set 2122 is drivably connected to the worm 222.

In an embodiment, the drive gear set 2122 includes a first drive gear 2123 and a second drive gear 2124. The first drive gear 2123 is fixedly sleeved on an exterior of the drive shaft 2121. The second drive gear 2124 is fixedly arranged in an end of the worm 222. The first drive gear 2123 is engaged with the second drive gear 2124, so as to enable synchronous rotation of the first drive gear 2123 and the second drive gear 2124.

In an embodiment, the drive shaft 2121 includes a first connecting segment 2125 and a second connecting segment 2126. A diameter of the first connecting segment 2125 is configured to be greater than that of the second connecting segment 2126. The first drive gear 2123 is fixedly sleeved on the first connecting segment 2125. An end of the lead screw 213 is provided with an insertion slot 2131, and the second connecting segment 2126 is inserted into the insertion slot 2131.

In an embodiment, the drive assembly 21 includes a connecting part 95 and a connecting hole 2127. The connecting hole 2127 is configured to pass through the lead screw 213 and the second connecting segment 2126. The connecting part 95 is inserted through the connecting hole 2127 to secure the second connecting segment 2126 and the lead screw 213.

In an embodiment, the connecting part 95 is a blot, or a screw.

In an embodiment, the transmission assembly 22 includes a first bearing 223 and a second bearing 224. The first bearing 223 and the second bearing 224 are sleeved on an exterior of the worm 222. The first bearing 223 and the second bearing 224 are arranged on two ends of the worm gear 221, respectively. The first bearing 223 is arranged between the second drive gear 2124 and the worm gear 221. The worm gear 221 is ensured to stably rotate by arranging the first bearing 223 and the second bearing 224.

In this present disclosure, the motor 211 is configured to drive the lead screw 213 to rotate, thereby allowing the lead screw nut 214, the frame assembly 3 and the worm gear 221 to move along the first direction 17. The motor 211 is drivably connected to the worm 222 to drive the worm 222 to rotate, so as to drive the worm gear 221 to rotate and cause the worm gear 221 to reciprocate and rotate, such that the garbage bag is gathered. Compared to multi-power source system in the prior art, the motor 211 is configured as a single-power source to reduce usage of multi-power source, simplify system construction, and decrease production cost, simultaneously avoiding energy waste, and achieving energy conservation and environment protection.

Referring to FIGS. 1-7, the trash can provided herein includes a synchronous pulley set 7, where the synchronous pulley set 7 is arranged in the second frame 32. The synchronous pulley set 7 includes a first synchronous pulley 71, a second synchronous pulley 72, and a synchronous belt 73. The first synchronous pulley 71 is arranged spaced apart from the second synchronous pulley 72 in the frame assembly 32. The first synchronous pulley 71 is engaged with the worm gear 221. The second synchronous pulley 72 is drivably connected to the first gathering assembly 4. The worm gear 221 is configured to drive the first synchronous pulley 71 to rotate. The synchronous belt 73 is sleeved on the first synchronous pulley 71 and the second synchronous pulley 72, so as to enable synchronous rotation of the first synchronous pulley 71 and the second synchronous pulley 72.

According to an embodiment in FIGS. 3-7, the trash can provided herein includes an idle gear 74, where the idle gear 74 is arranged between the second synchronous pulley 72 and the first gathering assembly 4. The second synchronous pulley 72 is configured to drive the first gathering assembly 4 to rotate via the idle gear 74.

In an embodiment, the synchronous pulley set 7, the idle gear 74, and the first gathering assembly 4 are arranged in the second frame 32.

In an embodiment, the first gathering assembly 4 includes a first drive wheel set 42 and a first drive belt 43. The first drive wheel set 42 is connected to the idle gear 74. The first drive belt 43 is sleeved on the first drive wheel set 42. The first drive belt 43 is driven via the first drive wheel set 42 to move along an outer wall of the first drive wheel set 42.

In an embodiment, the first drive wheel set 42 includes a first drive wheel 44, a second drive wheel 45, and a third drive wheel 46. The first drive belt 43 is sleeved on outer walls of the first drive wheel 44, the second drive wheel 45, and the third drive wheel 46, respectively. The first drive wheel 44 is drivably connected to the idle gear 74. The first drive wheel 44, the second drive wheel 45, and the third drive wheel 46 are configured to enclose to form a rough triangular shape.

In this embodiment, the first drive wheel 44 includes two pulleys and a gear. The gear is arranged between the two pulleys, and the gear, and the two pulleys are arranged coaxially. Two pulleys with the same size arranged coaxially are combined with each other to form the second drive wheel 45. Two pulleys with the same size arranged coaxially are combined with each other to form the third drive wheel 46. The number of the first drive belt 43 is two. One of the two first drive belts 43 is sleeved on the first drive wheel 44, the second drive wheel 45, and the third drive wheel 46 at a top; the other of the two first drive belts 43 is sleeved on the first drive wheel 44, the second drive wheel 45, and the third drive wheel 46 at a bottom. The idle gear 74 is engaged with a middle gear of the first drive wheel 44 for transmission.

In an embodiment, the first drive wheel set 42 includes a tensioning wheel 47. An outer wall of the tensioning wheel 47 is configured to press against the first drive belt 43.

In an embodiment, the first drive wheel 44 and the second drive wheel 45 approach an edge of the second gathering assembly 5, and align with the edge of the second gathering assembly 5.

In an embodiment, the protruding portion 622 is arranged between the first drive wheel 44 and the second drive wheel 45. The protruding portion 622 is arranged in a gap formed by the two first drive belts 43. A gathering area of the garbage bag is increased by arranging the two first drive belts 43. The protruding portion 622 and the heating element 6 are arranged in a gap between the two first drive belts 43 to separate the opening of the garbage bag after melting from the main body of the garbage bag.

Referring to FIG. 7, the second gathering assembly 5 includes a second drive wheel set 52 and a second drive belt 53. The second drive wheel set 52 is drivably connected to the first drive wheel set 42. The second drive belt 53 is sleeved on the second drive wheel set 52. The second drive belt 53 is driven via the second drive wheel set 52 to move along an outer wall of the second drive wheel set 52. The first contact area 41 is arranged in the first drive belt 43. The second contact area 51 is arranged in the second drive belt 53.

In an embodiment, the second drive wheel set 52 includes a first transmission wheel 54, a second transmission wheel 55, and a third transmission wheel 56. The second drive belt 53 is sleeved on outer walls of the first transmission wheel 54, the second transmission wheel 55, and the third transmission wheel 56, respectively. The first transmission wheel 54 is drivably connected to the first drive wheel 44. The first transmission wheel 54, the second transmission wheel 55, and the third transmission wheel 56 are configured to enclose to form a rough triangular shape.

In an embodiment, the first drive wheel 44 and the second drive wheel 45 approach an edge of the second gathering assembly 5, and align with the edge of the second gathering assembly 5. An edge of first transmission wheel 54 is configured to align with an edge of the second transmission wheel 55. The first drive belt 43 approaches the edge of the second gathering assembly 5, and the second drive belt 53 is parallel to and approaches the edge of the first gathering assembly 4 to form the first contact area 41 and the second contact area 51.

In an embodiment, a size of the first drive wheel 44 is configured to be the same as a size of the first transmission wheel 54, a size of the second drive wheel 45 is configured to be the same as a size of the second transmission wheel 55, and a size of the third drive wheel 46 is configured to be the same as a size of the third transmission wheel 56, thereby allow a rotating speed of the first drive wheel set 42 to be same as a rotating speed of the second drive wheel set 52.

In this embodiment, the first transmission wheel 54 includes two pulleys and a gear. The gear is arranged between the two pulleys, and the gear, and the two pulleys are arranged coaxially. Two pulleys with the same size arranged coaxially are combined with each other to form the second transmission wheel 55. Two pulleys with the same size arranged coaxially are combined with each other to form the third transmission wheel 56. The number of the second drive belt 53 is two. One of the two second drive belts 53 is sleeved on the first transmission wheel 54, the second transmission wheel 55, and the third transmission wheel 56 at a top; the other of the two second drive belts 53 is sleeved on the first transmission wheel 54, the second transmission wheel 55, and the third transmission wheel 56 at a bottom.

In an embodiment, the heating element 6 is arranged between the first transmission wheel 54 and the second transmission wheel 55. The heating element 6 is arranged in a gap formed by the two second drive belts 53.

In an embodiment, the trash can provided herein includes a rear wheel set 8. The rear wheel set 8 is arranged in the frame assembly 3. The rear wheel set 8 is arranged between the first drive wheel 44 and the first transmission wheel 54. The first transmission wheel 54 is drivably connected to the first drive wheel 44 via the rear wheel set 8.

In an embodiment, the number of rear wheels 81 is two. A first side of one of the two rear wheels 81 is engaged with a middle gear of the first drive wheel 44 for transmission. A second side of one of the two rear wheels 81 is engaged with a first side of the other of the two rear wheels 81. A second side of the other of the two rear wheels 81 is engaged with a middle gear of the first transmission wheel 54 for transmission.

In an embodiment, the trash can provided herein includes a rear supporting block 82. The rear wheel 81 is rotatably arranged in the rear supporting block 82. The rear supporting block 82 is connected to the second frame 32 and the third frame 33, respectively. The second frame 32 is configured to drive the rear supporting block 82 to move along the first direction 17 to cause the rear wheel 81 to move along the first direction 17. The rear supporting block 82 is configured to drive the third frame 33 to move along the first direction 17.

In an embodiment, the trash can provided herein includes a first pushing ramp 9. The first pushing ramp 9 is arranged at a side of the mounting portion 61 toward the first gathering assembly 4. The first pushing ramp 9 is arranged spaced apart from the heating element 6. The first pushing ramp 9 is arranged at a side of the heating element 6 away from a center of the trash can body 1. The first pushing ramp 9 has two first inclined surfaces 91 arranged along a vertical direction, and the two first inclined surfaces 91 are configured to form a blade-shaped structure. The first inclined surface 91 is arranged facing towards the heating element 6. The first inclined surface 91 is configured to move with the frame assembly 3 along the first direction 17. The first inclined surface 91 is configured to initially separate the opening of the garbage bag after melting from the main body of the garbage bag.

In an embodiment, the trash can provided herein includes a second pushing ramp 92. The second pushing ramp 92 is arranged in the rear supporting block 82. The second pushing ramp 92 is arranged spaced apart from the first pushing ramp 9. The second pushing ramp 92 is arranged at a side of the first pushing ramp 9 away from the heating element 6. The second pushing ramp 92 is provided with a second inclined surface 93. The second inclined surface 93 is parallel to the first inclined surface 91. When the first inclined surface 91 fails to completely separate the opening of the garbage bag from the main body of the garbage bag, the second inclined surface 93 can continue separating to ensure the opening of the garbage bag after melting to be completely separated from the main body of the garbage bag.

In an embodiment, the second pushing ramp 92 includes two pushing arms 94 and a connecting part 95. The two pushing arms 94 are symmetrically arranged along a vertical direction. The connecting part 95 is arranged between the two pushing arms 94. The pushing arm 94 is provided with the second inclined surface 93. The two pushing arms 94, and the connecting part 95 are integrally arranged.

In an embodiment, the pushing arm 94 includes a pushing portion 941, a fixing portion 942, and a clamping portion 943. The pushing portion 941 is connected to the fixing portion 942, where the fixing portion 942 is horizontally arranged, and the pushing portion 941 is obliquely arranged with respect to the fixing portion 942. The fixing portion 942 is provided with a fixing hole 944. The second pushing ramp 92 is configured to pass through the fixing hole 944 via a fixing element to be fixedly connected to the rear supporting block 82. The clamping portion 943 is arranged in a center of the pushing portion 941. Two clamping portions 943 are arranged on two sides of the pushing portion 941, respectively. Two rear wheels 81 are arranged inside the two clamping portions 943, respectively.

In an embodiment, the second pushing ramp 92 includes a retaining edge 96. The retaining edge 96 is arranged at a side of the pushing arm 94. The number of the retaining edge 96 is two. The two retaining edges 96 are respectively arranged on opposite sides of the second inclined surface 93 to enable the opening of the garbage bag to move along the second inclined surface 93 and be cut.

In the present disclosure, the opening of the garbage bag is completely separated from the main body of the garbage bag through the first pushing ramp 9 and the second pushing ramp 92.

Referring to FIG. 7, the trash can provided herein includes a sensor 14. The sensor 14 is arranged in the accommodating slot 11. The frame assembly 3 includes a fourth frame 34. A first end of the fourth frame 34 is connected to the third frame 33. A second end of the fourth frame 34 is slidably connected to a side wall of the accommodating slot 11. The fourth frame 34 is driven via the third frame 33 to move along the first direction 17. The fourth frame 34 is arranged below the third frame 33. The sensor 14 is arranged in the fourth frame 34. An end of the third frame 33 is slidably connected to the rear supporting block 82 via a rotation shaft. The rotation shaft is coaxially arranged with the first transmission wheel 54. The third frame 33 and the second gathering assembly 5 are configured to rotate around the rotation shaft. When there is a protrusion inside the garbage bag that hinders the packaging of the garbage bag, this protrusion will cause the second gathering assembly 5 and the third frame 33 to rotate as a whole around the rotation shaft in a direction away from the first gathering assembly 4. When the third frame 33 rotates to contact with the sensor 14, the sensor 14 will send a signal to enable the trash can to sound an alarm.

In an embodiment, the trash can provided herein includes a return spring 15. A first end of the return spring 15 is connected to a side wall of the trash can body 1, and a second end of the return spring 15 is connected to an end of the third frame 33. When the trash can sounds the alarm, the operator removes the protrusion to reset the third frame 33 and the second gathering assembly 5 under an action of the return spring 15, so as to enable the trash can to normally operate.

In an embodiment, the trash can provided herein includes a controller 16. The controller 16 is arranged in the trash can body 1. The controller 16 is electrically connected to the motor 211 and the sensor 14. The controller is configured to control the opening and closing of motor 211, and receive a signal from the sensor 14 to sound an alarm.

The aforementioned embodiments are preferred embodiments of the present disclosure, and not intend to limit this present disclosure. Within the spirit and principle of the present disclosure, any equivalent structural replacement which are obtained by utilizing the content of the embodiments and the accompanying figures, or directly/indirectly applied in other related technical fields, shall fall within the scope of the disclosure defined by the appended claims.

What is claimed is:

1. A trash can, comprising:
a drive mechanism;
a frame assembly;
a first gathering assembly;
a second gathering assembly; and
a heating element;
wherein the drive mechanism is configured to move along a first direction; the frame assembly is arranged along a second direction; and the first direction is perpendicular to the second direction;
the frame assembly is connected to the drive mechanism, and the drive mechanism is configured to drive the frame assembly to reciprocate along the first direction;
the first gathering assembly and the second gathering assembly are provided on the frame assembly; and the frame assembly is configured to be driven by the drive mechanism to cause the first gathering assembly and the second gathering assembly to move along the first direction;
the first gathering assembly is drivably connected to the drive mechanism, and the second gathering assembly is drivably connected to the first gathering assembly, so as to enable synchronous rotation of the first gathering assembly and the second gathering assembly; and the first gathering assembly is configured to be at least partially in contact with the second gathering assembly, such that a garbage bag is gathered to a contact area between the first gathering assembly and the second gathering assembly; and
the heating element is arranged in the first gathering assembly or the second gathering assembly; and the heating element is configured to cut and seal the garbage bag.

2. The trash can of claim 1, wherein the drive mechanism comprises a drive assembly and a transmission assembly; the drive assembly and the transmission assembly are arranged along the first direction; the frame assembly is connected to the drive assembly; the drive assembly is configured to drive the frame assembly to reciprocate along the first direction; the transmission assembly is partially arranged in the frame assembly; and the transmission assembly is drivably connected to the drive assembly and the first gathering assembly.

3. The trash can of claim 2, wherein the drive assembly comprises a motor, a lead screw and a lead screw nut; the motor is connected to the lead screw; the lead screw nut is threadedly connected to the lead screw; the frame assembly is connected to the lead screw nut; the motor is configured to drive the lead screw to rotate to cause the lead screw nut to reciprocate along the lead screw; and the lead screw nut is configured to drive the frame assembly to move along the first direction.

4. The trash can of claim 3, wherein the transmission assembly comprises a worm gear and a worm; the worm is drivably connected to the motor; the worm gear is sleeved on the worm; the motor is configured to drive the worm to rotate, so as to drive the worm gear to rotate; the worm gear is arranged in the frame assembly; the frame assembly is configured to drive the worm gear to reciprocate along the worm; and the worm gear is drivably connected to the first gathering assembly.

5. The trash can of claim 4, further comprising:
a synchronous pulley set arranged in the frame assembly;
wherein the synchronous pulley set comprises a first synchronous pulley, a second synchronous pulley and a synchronous belt; the first synchronous pulley is arranged spaced apart from the second synchronous pulley in the frame assembly; the first synchronous pulley is engaged with the worm gear; the second synchronous pulley is drivably connected to the first gathering assembly; the worm gear is configured to drive the first synchronous pulley to rotate; and the synchronous belt is sleeved on the first synchronous pulley and the second synchronous pulley to allow the first synchronous pulley and the second synchronous pulley to rotate synchronously.

6. The trash can of claim 5, wherein the first gathering assembly comprises a first drive wheel set and a first drive belt; the first drive wheel set is drivably connected to the second synchronous pulley; the first drive belt is sleeved on the first drive wheel set; and the first drive belt is configured to be driven by the first drive wheel set to move along an outer peripheral surface of the first drive wheel set.

7. The trash can of claim 6, wherein the second gathering assembly comprises a second drive wheel set and a second drive belt; the second drive wheel set is drivably connected to the first drive wheel set; the second drive belt is sleeved on the second drive wheel set; the second drive belt is configured to be driven by the second drive wheel set to move along an outer peripheral surface of the second drive wheel set; and the first drive belt is configured to be at least partially in contact with the second drive belt.

8. The trash can of claim 1, further comprising:
a first pushing ramp;
wherein the first pushing ramp is arranged in the second gathering assembly; the first pushing ramp is arranged spaced apart from the heating element; the first pushing ramp comprises a first inclined surface, wherein the first inclined surface is arranged facing towards the heating element; and the first pushing ramp is configured to move with the frame assembly along the first direction.

9. The trash can of claim 8, further comprising:
a second pushing ramp;
wherein the second pushing ramp is arranged spaced apart from the first pushing ramp; the second pushing ramp comprises a second inclined surface, wherein the second inclined surface is parallel to the first inclined surface; the second inclined surface is configured to cooperate with the first inclined surface to separate an opening of the garbage bag from a main body of the garbage bag after thermal sealing.

10. The trash can of claim 1, further comprising:
an abutting mechanism arranged in the frame assembly;
wherein the abutting mechanism is configured to protrude beyond the first gathering assembly, and press against an opening of the garbage bag to eliminate a gap between two sides of the garbage bag.
